(19) United States
(12) Patent Application Publication
(10) Pub. No.: US 2009/0032671 A1
(43) Pub. Date: Feb. 5, 2009

(54) VEHICLE ANCHORING SYSTEMS AND METHODS FOR THEIR USE

(76) Inventors: Bruce W. Perry, Lincoln, RI (US); Kevin P. Trainor, Greenville, RI (US)

Correspondence Address: BOWDITCH & DEWEY, LLP, 311 MAIN STREET, P.O. BOX 15156, WORCESTER, MA, 01615-0156, US

(21) Appl. No.: 12/108,464

(22) Filed: Apr. 23, 2008

Related U.S. Application Data
(60) Provisional application No. 60/925,742, filed on Apr. 23, 2007.

(51) Int. Cl. B60R 99/00; B65D 63/00

(52) U.S. Cl. 248/499

(57) ABSTRACT

An anchoring system for a vehicle, and vehicle based shelter systems are disclosed herein. In one embodiment, the vehicle based shelter system comprising a vehicle and an anchoring system. The anchoring system can comprise a tether that can extend from the securement device and attach to the vehicle. The anchoring system is capable of restraining or limiting movement of the vehicle to prevent it from moving from its point of origin in any direction greater than or equal to about 3 feet. The anchoring system is capable of securing the vehicle to the ground, directly or indirectly.

### TECHNICAL FIELD

This disclosure generally relates to vehicle anchoring systems, vehicle based sheltering systems and methods for their use.

### BACKGROUND

In efforts to provide protection from weather phenomena, various forms of shelter systems have been employed. One such shelter design is the subterranean shelter (e.g., bomb shelter). Subterranean shelters are constructed under the surface of the earth such that the earth surrounding the shelter can provide a barrier between the shelter and any conditions above the surface of the earth (also referred to as “above ground”). Subterranean shelters usually comprise an entrance (e.g., a door) that can be accessed from the surface such that individuals seeking refuge can easily enter and then descend into the shelter via a ladder or stairs. Commonly constructed of masonry materials, such as brick, cement block, and concrete, subterranean shelters are generally structurally robust, and therefore are effective temporary shelters.

Using similar construction materials as those employed for the construction of subterranean shelters, surface-based shelters (also referred to as above ground shelters) are also effective at providing shelter from undesirable weather phenomena. However, as above-ground shelters can require greater structural strength as they do not benefit from a natural barrier of earth disposed around them as do subterranean shelters.

Although subterranean and surface-based shelters have proven to provide safety for those seeking shelter from destructive natural phenomena, in many circumstances individuals cannot construct such a shelter as many do not have the land and/or resources to do so. Yet further, it has been well established that timber-based homes and/or structures (e.g., barns, garages, etc.) do not withstand the forces of undesirable weather phenomena as well as structures specifically designed to do so. Therefore, many individuals rely on suitable public shelters for safety in times of emergency. However, there are many people who do not have prompt access to such a public shelter.

Therefore, there exists a need for shelter systems that are readily accessible in emergency situations such that individuals can quickly seek refuge from devastating natural phenomenon. Such systems that can be provided at relatively low cost compared to alternative shelter systems, and do not require a large amount of land area to employ are even more desirable.

### BRIEF SUMMARY

Disclosed herein are vehicle based shelter systems and methods for their use. One embodiment is directed to a vehicle anchoring system, comprising a support member comprising a plurality of spaced apart recessed regions; a plurality of retention members, each retention member comprising an aperture, each retention member being connected to the support member such that the aperture is disposed over the recessed region; and a first and a second tether, each of the first and second tethers comprising opposing ends and a connector disposed at each of the opposing ends; wherein, in use, the first tether is connected at one end to a retention member and at the opposing end to the vehicle, and the second tether connected to a retention member at each of the opposing ends, such that the second tether extends through the vehicle compartment.

Another embodiment is directed to a vehicle-based shelter system, comprising a vehicle comprising an internal compartment, wherein the internal compartment is large enough for at least one person to fit therein; and an anchoring system comprising an anchoring device and a tether, wherein the tether can extend from the securement device and attach to the vehicle and wherein the securement device is capable of securing the vehicle such that the vehicle cannot roll over or travel from a point of origin in any direction greater than or equal to about 3 feet; wherein the anchoring system is capable of securing the securement device to the ground.

Another embodiment is directed to a method of anchoring a vehicle to a support member, comprising forming a plurality of spaced apart recessed regions in the support member; connecting a plurality of retention members to the support member, each retention member comprising an aperture, each retention member being connected to the support member such that the aperture is disposed over the recessed region; providing a first and a second tether, each of the first and second tethers comprising opposing ends and a connector disposed at each of the opposing ends; and connecting the first tether at one end to a retention member and at the opposing end to the vehicle, and connecting the second tether to a retention member at each of the opposing ends, such that the second tether extends through the vehicle compartment.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a perspective view of an exemplary vehicle based shelter system;

FIG. 2 is a top view of a retention member used in the system of FIG. 1;

FIG. 3 is a cross-sectional schematic view of the retention member shown in FIG. 2, anchored to the ground;

FIG. 4 is a cross-sectional schematic view of the engagement of a tether in the retention member shown in FIG. 3;

FIG. 5 is a cross-sectional schematic view of another exemplary retention member that can be used in the system shown in FIG. 1, anchored to the ground;

FIG. 6 is a perspective view of another exemplary vehicle based shelter system;

FIG. 7 is a perspective view of a retention member used in the system of FIG. 6, anchored to the ground;

FIG. 8 is a cross-sectional schematic view of the retention member shown in FIG. 7;

FIG. 9 is a perspective cut-away view of another exemplary anchoring device;

FIG. 10 is a perspective cut-away view of the anchoring device shown in FIG. 9;

FIG. 11 is a perspective and cut-away view of another exemplary anchoring device, which is motorized;

FIG. 12 is a side view of an exemplary drive box used in the anchoring device of FIG. 11;

FIG. 13 is a partial view of an exemplary locking system used in the anchoring device of FIG. 11;

FIG. 14 is a perspective view of another exemplary vehicle based anchoring system;

FIG. 15 is a front view of the vehicle based shelter system of FIG. 14;

FIG. 16 is a perspective cut-away view of another exemplary anchoring device;

FIG. 17 is a perspective cut-away view of the anchoring device of FIG. 16, having the locking-cog engaged with the ribbed-hub;

FIG. 18 is a vehicle based shelter system comprising a plurality of anchoring devices;

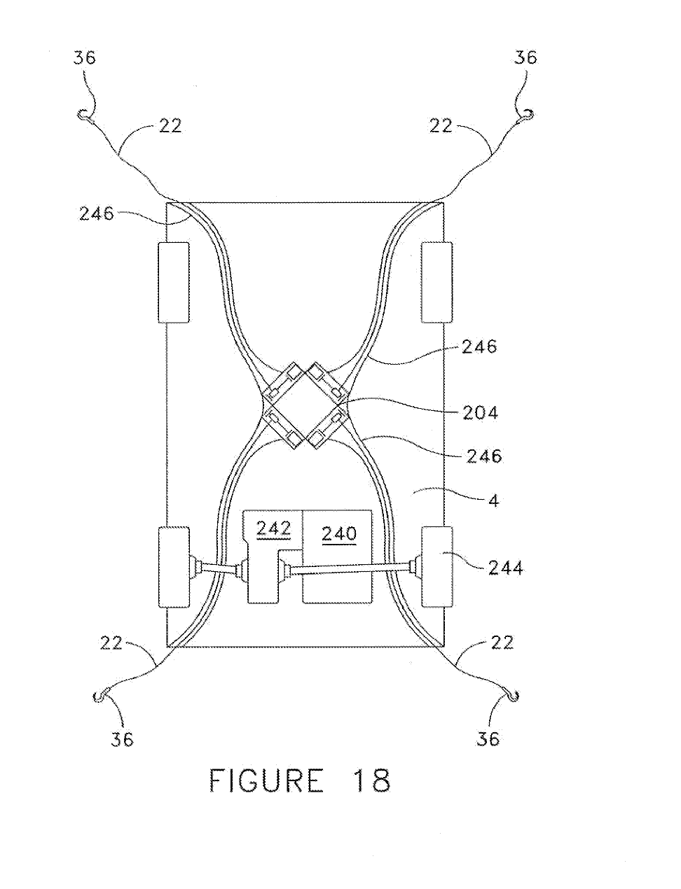

FIG. 19 is a perspective view of an exemplary configurable anchoring system; and

FIG. 20 is a perspective view of the configurable anchoring system of FIG. 19.

### DETAILED DESCRIPTION

Disclosed herein are vehicle anchoring systems, vehicle based shelter systems, and methods for their use. The anchoring systems can be used to secure a vehicle (e.g., automobile, truck, etc.) to the ground, directly or indirectly, during any weather phenomena (e.g., tornado, hurricane, flood, etc.) so that the vehicle is retained in or near its initial position. When anchored to the ground, the vehicle can provide a relatively aerodynamic and structurally robust enclosure in which a person can seek shelter (hereinafter referred to as “shelter systems” or “systems”).

The present shelter systems are especially applicable for persons whom live in dwelling comprising timber construction which are susceptible to significant damage from tornadoes and/or hurricanes. The shelter systems disclosed herein are even more so applicable for people whom live in mobile homes (e.g., trailer homes), as they are especially susceptible to the effects of the winds produced by tornadoes and/or hurricanes due to their light weight construction and lack of a concrete foundation.

Several shelter systems are disclosed herein with references to individual figures. One of skill in the art will easily recognize that many of the components of each of these embodiments are similar to each other. However, various components can be added or omitted based on various design choices. As such, various elements and/or features can be introduced in a given figure with the understanding that the disaster shelter systems can be modified as taught herein and/or to include features illustrated in other embodiments. Each of these elements is first introduced in the discussion of a given figure, but is not repeated for each embodiment for conciseness. Rather, distinct structure is discussed relative to each figure/embodiment.

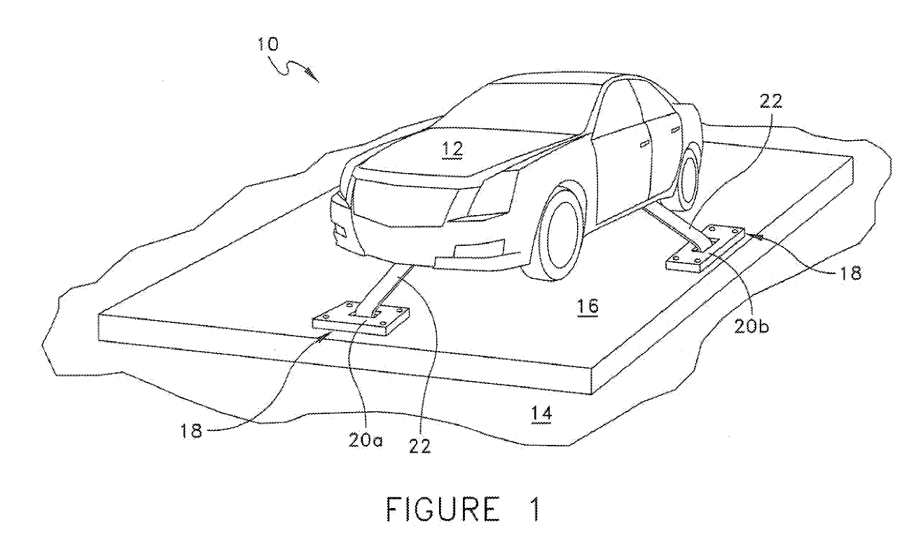

FIGS. 1-4, when taken together, show an exemplary vehicle anchoring system 10 in use, anchoring a vehicle 12 indirectly to the ground 14. The vehicle 12 can comprise any vehicle in which one or more people can fit therein, such as a cars, trucks (e.g., pick-up truck), vans, panel vans, box trucks, tractors (i.e., tractor-trailers), and so forth. In the exemplary embodiment illustrated in FIG. 1, a car is employed having a passenger compartment capable of providing shelter for a plurality of people therein. It is to be noted that if the vehicle 12 comprises a trunk, and/or other cargo area, persons can also seek refuge therein as well (it is noted that many vehicles are manufactured with emergency trunk releases that glow in the dark and can be readily used to exit the trunk). Further, it is noted that one benefit of seeking refuge in a trunk is that there is a reduced risk of injury from shattering glass (e.g., windows, windshield, etc.).

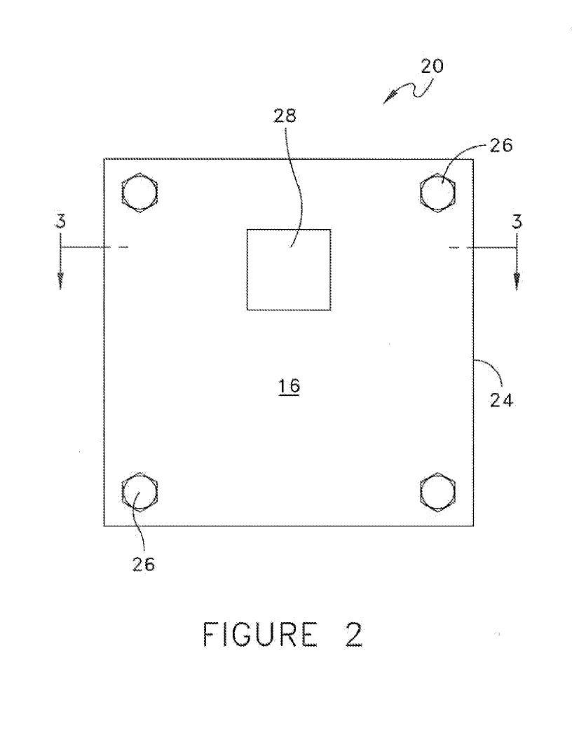

As shown, anchoring system 10 comprises a support member 16 and a plurality of anchoring devices 18. Each anchoring device 18 comprises a retention member 20 and a tether 22. As shown in FIG. 2, in the present embodiment, each retention member 20 comprises an outside edge 24, a plurality of internally threaded bores 26 disposed adjacent to edge 24, and an aperture 28 disposed between the bores 26. As illustrated, the retention members 20 have a square geometry of approximately 12 inches on each side (i.e. 12 inches×12 inches×½ inch). However, it should be understood that the retention members 20 can comprise any configuration (e.g., circular, oblong, irregular, and so forth) and/or thickness.

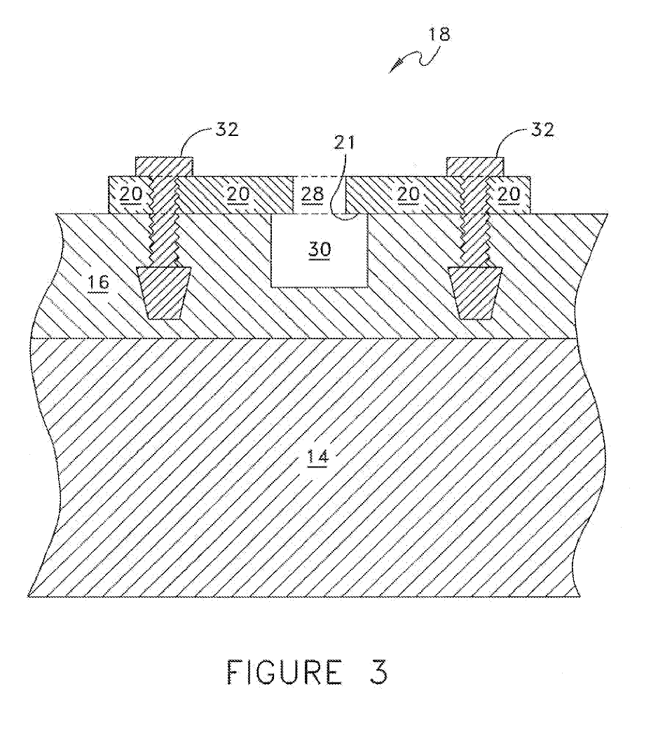

In the present embodiment, as shown in FIG. 3, support member 16 comprises a recessed region 30, and each retention member 20 is connected to support member 16 such that aperture 28 is disposed above recessed region 30 of support member 16, and is secured to the support member 16 by externally threaded anchors 32 received into bores 26. Nuts 34 can be threaded onto the anchors 32 to secure the retention member 20 to the support member 16, which in the present embodiment comprises a poured concrete driveway. Thus, as shown, anchors 32 extend through the retention member 20 and into the support member 16, and optionally through the support member 16 and into the ground 14. Optionally, as shown, externally threaded anchors 32 can comprise expanding anchor-bolts that can be inserted into bores 26 and secured (e.g., expanded). Also optionally, glue, epoxy, or the like (not illustrated) can be disposed in bores 26 prior to inserting the anchors 32, in order to provide an adhesive or chemical bond between the anchor 32 and the retention member 20, in addition to the mechanical bond.

The retention members 20 can be connected to support member 16 such that they are a distance of about 6-8 inches from the vehicle, when the vehicle is parked on the support member 16. It should be understood that any number of retention members can be used, in any configuration around the vehicle, and that the retention members can be disposed at any desired distance from the vehicle, which can vary.

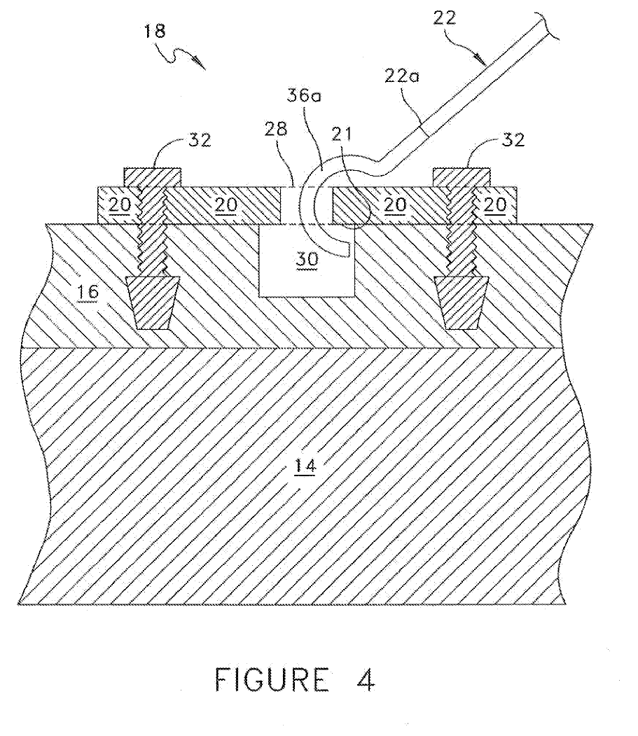

As shown in FIG. 4, each tether 22 comprises a first end 22a including a first connector 36a disposed at the first end 22a, and a second end 22b (not illustrated) including a second connector 36b (not illustrated) disposed at the second end 22b.

The tethers 22 can comprise any material capable of withstanding the external forces described above. In the present embodiment, the tethers comprise ratchet-straps and/or tie-downs. In some embodiments, the tethers are desirably flexible. For example, cables, webbing or chains can be employed comprising metals (e.g., copper, aluminum, nickel, iron, chromium, and so forth), metal alloys (e.g., stainless materials, iron alloys, nickel-chromium superalloys, and so forth), and polymeric materials. Exemplary polymeric materials include polyesters (e.g., polyethylene terephthalates, polybutylene terephthalates, and so forth), polyamides (e.g., polyparaphenylene terephthalamide (e.g., Kevlar®, E.I du Pont de Nemours and Company), polycaprolactams (Nylons®, E.I du Pont de Nemours and Company), polyetherimides (e.g., Ultem®, General Electric Company), polyimides, polycarbonates, polypropylenes, polyethelenes, and so forth. For example, in one specific embodiment an 8×19 fiber-core steel cable (i.e., a cable comprising 8 woven cords comprising 19 filaments in each) having a Nylon® outer coating can be employed. To be even more specific, the cable can have an outer diameter of about ¼ inch, which could provide a break strength of about 5000 lbs. It is to be noted however that the specific configuration and material(s) employed can be tailored based on the variables of the specific need, such as size of the vehicle (i.e., surface area), plurality of anchoring devices, and so forth.

The connectors 36 can comprise any configuration which is capable of being attached to retention members 20 and to the vehicle. For example, in the present embodiment, connectors 36a,b comprise hooks that are configured to extend through aperture 28 of retention member 20, and when under tension, to engage the underside 21 of retention member 20. Although any design can be employed, it is desirable that the connectors can be readily attached to the vehicle so that the anchoring system can be quickly assembled in an emergency situation. Alternative configurations can comprise carabiner-like designs, bolt-on type designs (e.g., a U-shaped portion comprising a bolt extending there through, or even a plate that can be quickly bolted to the vehicle 12), loop-like designs (e.g., a loop of webbing that can be wrapped around the car or the tire), and so forth. It is to be interpreted that one skilled in the mechanical arts could conceive various attachment devices that can be used to attach the tether 22 to the vehicle, including, but not limited to, screws, bolts, rivets, pins, staples, nails, brads, connectors, clips, snaps, fittings, and so forth, as well as combinations comprising at least one of the foregoing.

The retention members 20, anchors 32, nuts 34 and connectors 36 all can comprise metals (e.g., aluminum, iron), metal alloys (e.g., stainless steels) or other materials capable of withstanding the external forces exerted during use.

In the present embodiment, the anchoring system 10 comprises a first retention member 20a disposed adjacent to the front of the vehicle, a second retention member 20b disposed on a side of the vehicle, and a third retention member 20c (not illustrated), disposed on a side of the vehicle opposite the second retention member 20b. Those of ordinary skill in the art will recognize that the position of the retention members 20 in relation to the vehicle 12 can be varied depending upon a variety of factors, including, but not limited to, the shape and size of the vehicle, the material from which the support member is formed, and the like.

In operation, anchoring system 10 is capable of restraining the vehicle 12 when it is acted upon by an external force, such as wind generated by a tornado or other natural phenomenon (e.g., a hurricane), which can reach speeds of several hundred miles-per-hour (mph). For clarification, the term “restrained” is to be interpreted as limiting the movement of the vehicle to less than about 3 feet, and desirably less than about 6 inches, in any direction from its point of origin.

Movement of the vehicle when subjected to external forces (such as wind) can be influenced by various factors including, but not limited to, the amount of tension in the tethers, the amount of elongation in the tethers, and the like. In addition, it is also desirable to reduce the potential swaying, and/or rocking, of the vehicle when the vehicle is subjected to external forces, which can make the individuals within the vehicle feel less secure. Therefore, it is desirable that tension is imparted into the tethers to reduce these types of motion. For example, if the tethers can be tensioned such that the vehicle's suspension (not shown) is compressed (e.g., compression of leaf springs, struts, springs, etc.), the ability of the vehicle to sway or rock in the wind can be reduced. It is to be understood that based on the configuration of the vehicle, the tethers can be slack or tensioned.

To anchor the vehicle 12 to the ground 14, as shown in FIG. 1, first connector 36a of a tether 22 can be engaged with retention member 20a, and the second connector 36b of the same tether 22 can be engaged with the vehicle 12. As shown in FIG. 1, retention member 20a is engaged with the vehicle 12 at the front end. A second tether 22 extends through the vehicle compartment to connect retention members 20b,c via connectors 36 a,b.

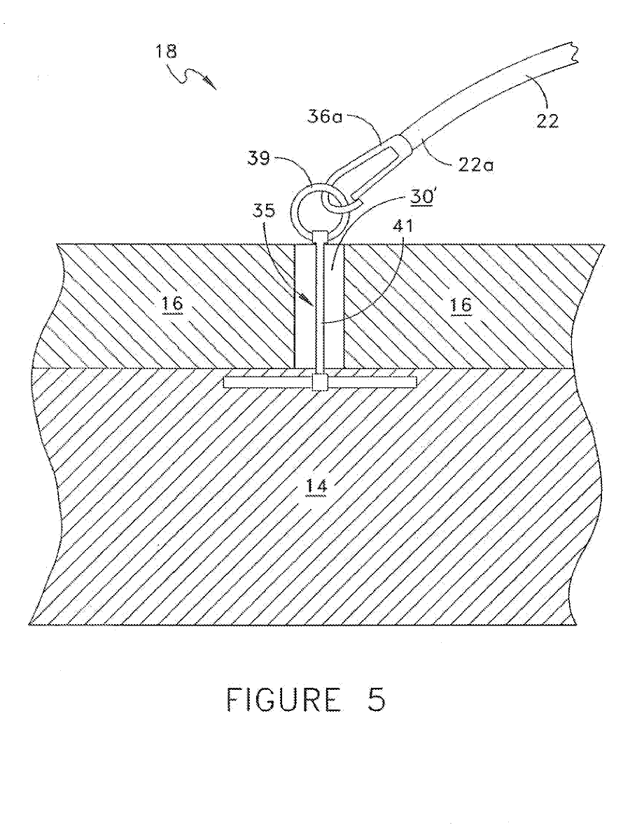

Another embodiment of an anchoring device 18 is shown in FIG. 5. As shown, anchoring device 18 comprises an anchoring member 35 to which a connector 36 can be removably connected. As shown, anchoring member 35 comprises a rod 37, a connecting device 39, and a flexible cable 41 connecting the rod 37 and the connecting device 39. To assemble the anchoring device 18, rod 37 can be inserted through bore 30, and into the ground 14, such that the rod 37 is disposed parallel to the ground surface. Thereafter, the bore 30 can be backfilled with, for example, concrete. In the present embodiment, connectors 36a,b comprise carabiners, which are configured to engage connecting devices 39, regardless of whether the tether is under tension or is slack. When not in use, the connecting devices 39 can fold onto the retention members 20 and, if desired, retention members 20 can comprise a recessed region (not illustrated) into which the rings can fold, such that they are flush with the surface of the retention member.

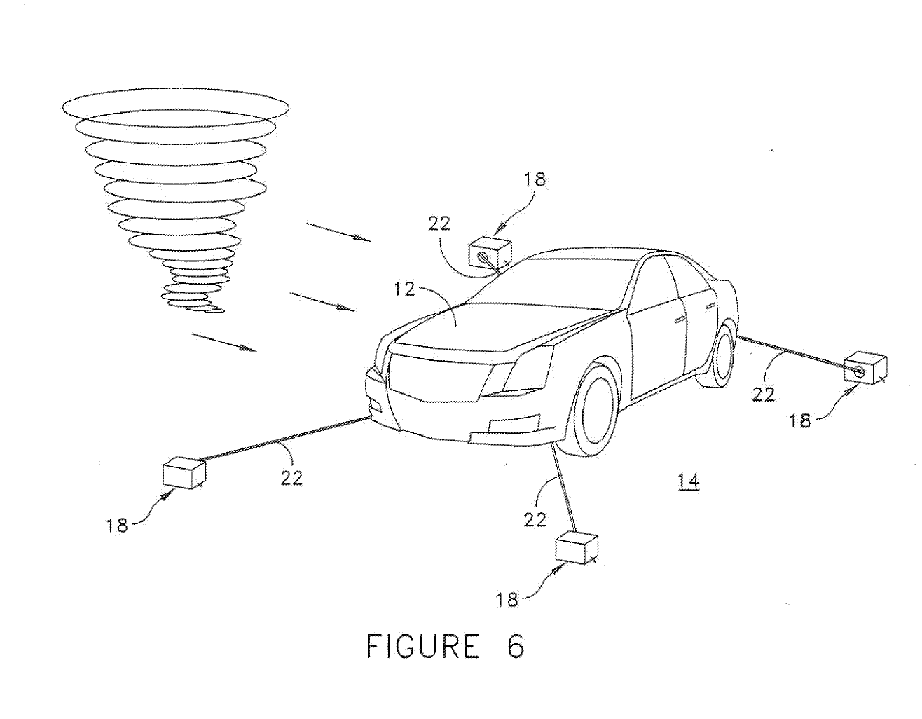

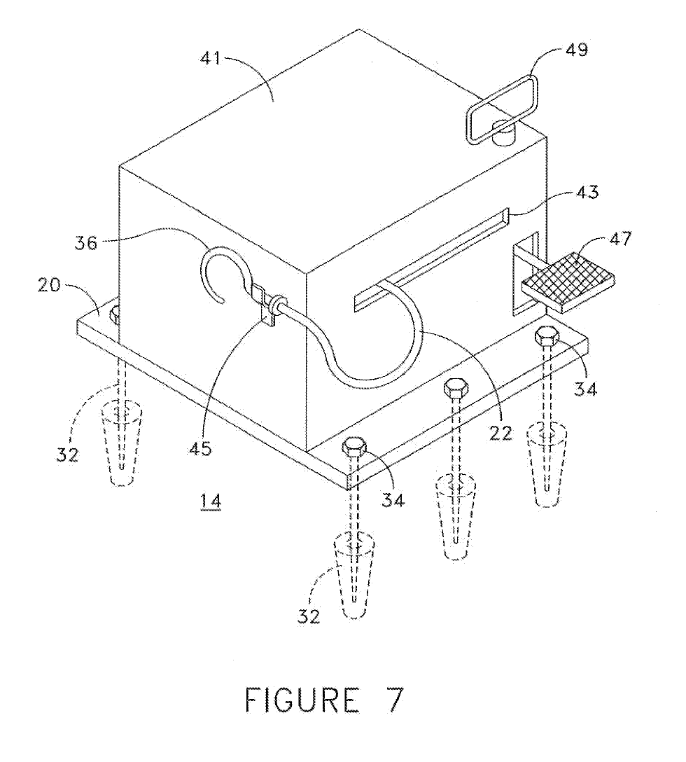

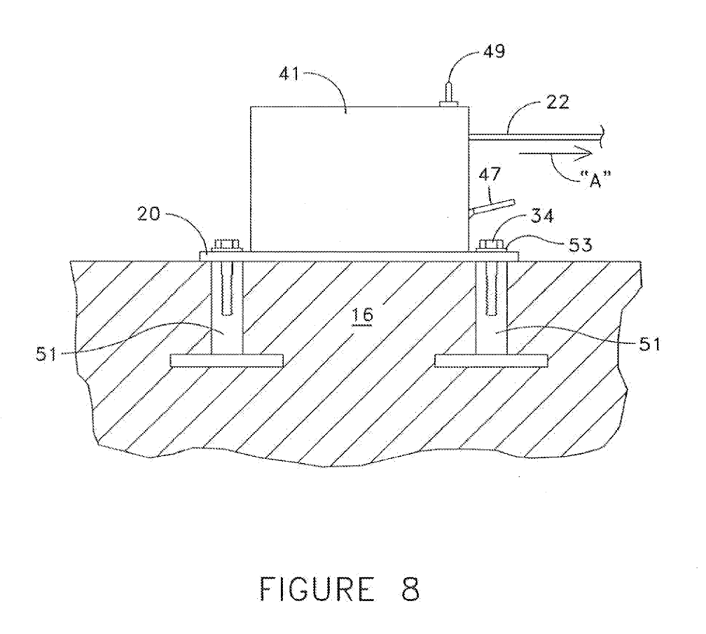

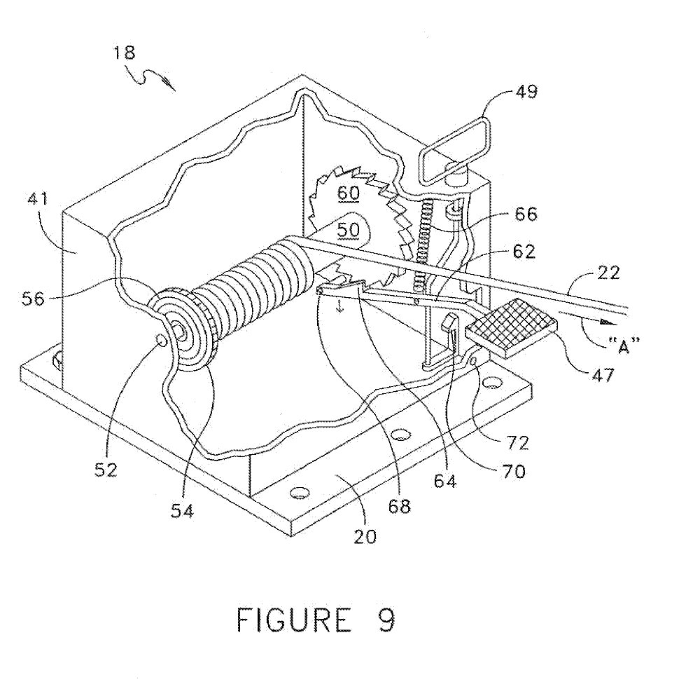

FIGS. 6-10, when taken together, show another exemplary anchoring system 10 comprising a plurality of anchoring devices 18 that are anchored directly to the ground 14. As shown in FIG. 7, in the present embodiment, anchoring devices 18 comprise a housing 41 supported on a retention member 20. Housing 41 comprises a slot 43 through which a tether 22 can pass. Attached to the tether 22 is a connector 36 that is capable of connecting to a vehicle 12. In the present embodiment, the tethers are desirably flexible, which allows it to be stowed in the housing 41 when not in use. The connector 36 can be secured by a clip 45 to the housing 41 for stowage. The anchoring system 18 also comprises a foot pedal 47 and a handle 49, which will be described in relation to FIGS. 8-9.

As shown in FIG. 7, anchoring devices 18 each comprise six externally threaded anchors 32 that are used to secure the retention member 20 to the ground 14, in the same manner described above. The ground 14 can comprise any material, such as soil (e.g., soil having grass thereon), rock, asphalts, crushed stone, gravel, cement, concrete, concrete pavers (e.g., fabricated blocks), cobblestones, cement block, and so forth. It is noted that the term “ground” is to be interpreted as a general term for the surface on which the vehicle and/or at least one component of the system 10 is disposed (e.g., anchoring device 18 and the vehicle 12) and/or secured thereto. For example, in FIG. 1, the ground 14 can comprise a poured concrete driveway on which the vehicle 12 is disposed and to which the anchoring devices 18 are connected. In an alternative embodiment (not shown) the vehicle 12 can be disposed on the ground 14 which comprises a mixture of gravel and soil and the anchoring devices 18 are disposed on individual concrete pads and/or footings (to be discussed later).

The anchoring devices 18 can be configured such that they can be secured to the ground 14 utilizing various methods which will be disclosed at various places herein. It is also noted that anchoring devices 18 can also be secured to various other structures, such as walls (e.g., walls within a garage), or any other surface or structure.

Although the anchoring systems 18 employed in the illustrated configuration comprises a retention member 20, threaded anchors 32 and nuts 34, it is to be understood that the anchoring systems 18 can comprise various configurations which may be secured to the ground 14 and/or a support member 18, and that various techniques can be used to do so. To be more specific, the anchoring systems 18 can comprise any configuration and/or design that is capable of being secured to the ground 14, directly or indirectly, such that the anchoring system 10 can restrain the vehicle 12 when in use. It should be recognized that those of ordinary skill in the mechanical arts could envision many such configurations.

Although various anchoring systems 18 can be used, the specific anchoring system 18 employed can be tailored based on the specific properties of the material to which it is attached. To be more specific, if an anchoring system 18 is to be attached to the ground 14, the specific composition of the ground 14 can influence configuration of the anchoring system 18. For example, if the ground 14 comprises a structural material, such as a poured concrete driveway that comprises a sufficient thickness, an anchoring system 18 such as that illustrated in FIG. 2 can be employed. It is noted that the thickness of the concrete can affect the anchoring system 18. More specifically, if the concrete driveway is less than or equal to about two inches thick, the anchoring system 18s may need to be fortified with footings, pylons, metal rods, ground anchors, or other means to secure the anchoring system 18. In an alternative configuration however, if the concrete driveway comprises greater than two inches of concrete (e.g., 8 inches), an anchoring system 18 comprising threaded anchors 32 could be employed.

To install a threaded anchor 32, first a hole can be drilled into the concrete, wherein the threaded anchors 32 could be inserted. Once inserted, the threaded anchor 32 can be expanded to secure the threaded anchor 32 in the concrete. Next, the retention member 20 can be inserted over the threaded anchor 32 and the nut 34 can then be threaded thereon.

Referring now to FIG. 8, an alternative anchoring system 18 is illustrated. The anchoring system 18 comprises internally threaded bases 51 disposed within a support member 16, which in the present embodiment is a concrete pad. Anchors 32 pass through lock-washers 53 and retention member 20 to secure the retention member 20 to the support member 16. The internally threaded bases 51 are configured with a geometry that can resist being pulled out of the support member 16 when a tensile force is applied to the tether 22. The internally threaded bases 51 can be positioned in the support member 16 as it is formed in order to secure the bases therein after the concrete sets.

The anchoring systems and alternative anchoring systems discussed above are exemplary of the many variations that could be conceived and employed by one skilled in the mechanical arts. Therefore, they are exemplary and not intended to be inclusive. Rather, one skilled in the art can envision many such configurations which are applicable.

However the anchoring system 18 is secured to the ground 14 (or other structure), the anchoring system 18 functions to secure the vehicle when acted upon by external forces.

Referring now to FIG. 9, a perspective view of another exemplary anchoring system 18 is illustrated. In the illustration, the housing 41 of the anchoring system 18 has been cut-away so that the internal components can be viewed. The anchoring system 18 comprises a spool 50 on which the tether 22 can be wound or un-wound. The spool 50 is supported via a shaft 52 which is supported on either end by the housing 41 utilizing bearings (e.g., ball bearings, roller bearings, bushings, etc.) (not shown). On one end of the spool 50 is a plate 54, which is connected thereto. The plate 54 serves to contain the tether 22 as it is wound or un-wound on the spool 50. Connected to the plate 54 is a biasing member 56, which in the present embodiment is a watch spring connected on one end to the plate 54 and on its other end to the housing 41. The watch spring 56 is configured such that it is capable of imparting a rotational force on the spool 50 which urges the spool 50 to rotate in a direction that would cause the tether 22 to wind onto the spool 50 (e.g., if the tether 22 is fully unwound from the spool 50, the watch spring 56 can impart a force on the spool 50 that would cause the spool 50 to rotate and cause the tether 22 to wind there around).

The spool 50 is connected to a cog wheel 60 that is disposed on an end of the spool 50 that is opposite the plate 54. The cog wheel 60 and plate 54 are connected such that they rotate as one entity. A foot pedal 47 is connected to a lever 62 which is rotatably attached to the housing 41 at a pivot point 68. The lever 62 comprises a cog 64 that is capable of engaging with the cog wheel 60. When the cog 64 is engaged with the cog wheel 60, the cog wheel 60, spool 50, and plate 54 are incapable of rotating, even if a tensile force 44 is pulled on the tether 22. The lever 62 is biased to promote contact between the cog 64 and the cog wheel 60 via spring 66.

To unwind (i.e., deploy) the tether 22, the foot pedal 47 is depressed causing the cog 64 to disengage from the cog wheel 60. When the cog 64 disengages from the cog wheel 60, the spool 50, cog wheel 60 and plate 54 are allowed to rotate such that the tether 22 can be unwound from the spool 50. It is noted that the watch spring 56 imparts a rotational force on the spool 50 that opposes the deployment of the tether 22. However, if a tensile force 44 is imparted on the tether 22 that is greater than the force imparted on the spool 50 by the watch spring 56, the tether 22 can be unwound from the spool 50. To be more specific, it is desirable that the watch spring 56 can impart a force that is capable of winding the tether 22 onto the spool 50 when the tether 22 is fully deployed (i.e., the full length of the tether 22 is unwound from the spool 50). To be even more specific, it is desirable that the watch spring is capable of generating a tensile force in the tether 22 when the tether 22 is deployed and connected to a vehicle, such as greater than or equal to a 1 lb. tensile force, or even more specifically, greater than or equal to a 5 lb. tensile force, or even more specifically, greater than or equal to a 10 lb. tensile force.

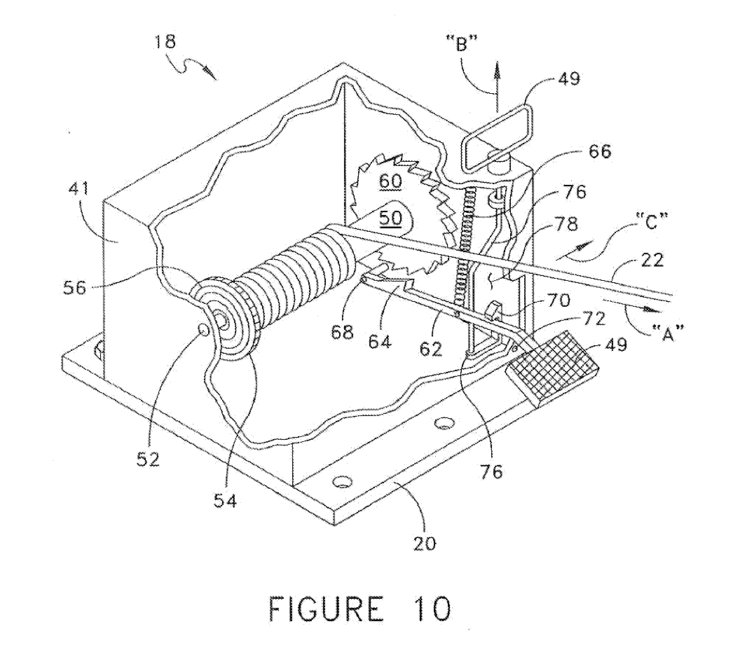

It is desirable that the foot pedal 47 is capable of remaining in a depressed configuration such that the full length of the tether 22 can be pulled from the anchoring system 18 without having to maintain depression of the foot pedal 47, such as when the user is connecting a connector 36 (not shown) to the vehicle 12 (not shown). Therefore, the anchoring system 18 can comprise a hook 70 that is capable of engaging the lever 62 such that the lever 62 and foot pedal 47 remain in a depressed configuration, as illustrated in FIG. 10. Referring now to FIG. 10, the hook 70 is rotatably connected to the housing 41 at a pivot point 72. When the foot pedal 47 is depressed, the lever 62 is engaged by the hook 70 as the weight of the handle 49 and connecting rod 76 causes the hook 70 to rotate over the top surface of the lever 62, locking it there under. To reengage with the cog 64 with the cog wheel 60, the lever 62 can be releasing from the hook 70 by lifting the handle upward, as indicated by directional arrow “B.” Lifting the handle 49 upward causes a connecting rod 76 attached to the handle 49 to lift on a lever extension 76 causing the hook 70 to rotate in a direction indicated by directional arrow “C,” which disengages the lever 62 from the hook 70. When the lever 62 disengages from the hook 70, the lever 62 is pulled upward by spring 66 and the cog 64 is engaged with the cog wheel 60.

A shelter system 10 can be used whenever desired, such as when a tornado, hurricane, flood, or so forth, is likely. To assemble the system 10, the connector 36 is to be attached to the vehicle 12. To attach the connector 36 to the vehicle 12, a portion of the tether 22 may need to be deployed from the anchoring system 18. If so, the foot pedal 47 is depressed to disengage the cog 64 from the cog wheel 60, and lock the lever 62 in a depressed orientation, so that the spool 50 is allowed to rotate and the tether 22 can be drawn from the anchoring system 18. Once the foot pedal 47 has been depressed, the user can grasp the connector 36 (or the tether 22) and pull the connector 36 towards the vehicle 12. When an adequate amount of tether 22 has been pulled from the anchoring system 18 such that the connector 36 can be attached to the vehicle 12, the connector 36 is attached to the vehicle 12 and the user can let go of the connector 36 and/or tether 22, leaving it connected to the vehicle 12. It is noted, that as the tether 22 is pulled from the anchoring system 18, the watch spring 56 can desirably resist the deployment of the tether 22, keeping the tether 22 taut. The tether 22 is desirably taut such that slack in the length of tether 22 spanning from the anchoring system 18 to the vehicle 12 is reduced, as the reduction in slack can reduce the distance the vehicle 12 can travel before the tether 18 inhibits further travel.

Once the connector 36 has been connected to the vehicle 12, the cog 64 is engaged with the cog wheel 60 such that additional tether 22 cannot be deployed from the anchoring system 18, hence securing the vehicle 12. To engage the cog 64 with the cog wheel 60, the user pulls the handle 42 upward causing the cog 64 to engage with the cog wheel 64, as previously described.

The process described above is repeated for each anchoring system 18 the system 10 comprises. Once all of the anchoring devices 18 have been connected to the vehicle 12 and engaged, the vehicle 12 can be considered secured to the ground 14. The user, and any other individuals that are not already in the vehicle 12, can then seek refuge in the vehicle 12.

In yet another method of use, the system 10 can be left in a ready state prior to use, which can decrease the amount of time due to assemble the system 10. To be more specific, the system 10 is in a ready state when the connector 36 can be easily located (e.g., for example at night it may be difficult to see the system clearly) and the foot pedal 47 is already in the depressed configuration such that the user need only to grasp the connector 36, pull it towards the vehicle (which can deploy additional tether 22 if needed), connect the connector 36 to the vehicle 12, and pull upward on the handle 49.

It t is noted that the system 10 can comprise additional features to enable speedy assembly. For example, the system 10 can incorporate battery operated and/or hard-wired lighting such that the connector 36, handle 49 and/or vehicle 12 can be illuminated in the dark. Further, glow-in-the-dark materials (e.g., glow in the dark tape) can be employed to ease the location of various components of the system 10 at night.

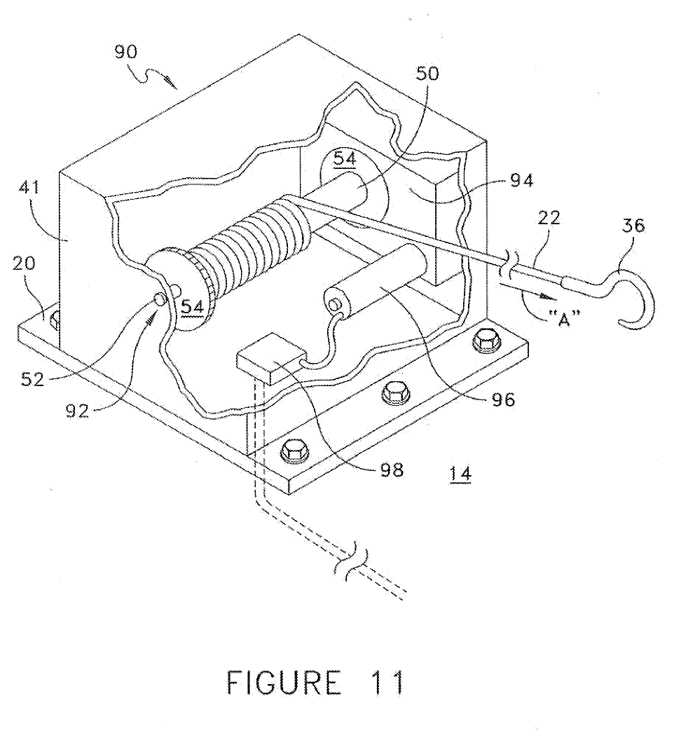

Turning now to FIG. 11, a perspective view of an exemplary motorized anchoring device 90 is illustrated. The motorized anchoring device 90 comprises a housing 41 that has been cut-away to view the exemplary components therein. The motorized anchoring device 90 comprises a spool 50 onto which the tether 22 can be wound or unwound. Plates 54 are disposed on both ends of the spool 50, which serve to maintain the tether 22 as it is wound onto the spool 50. Attached to the plates 54 are shafts 52 that can be employed to rotatably support the spool 50 and plates 54 (hereinafter collectively referred to as the spool 50). On a first end 92, the spool 50 is supported by the shaft 52 which engages with the housing 41, wherein the housing 41 supports the shaft 52 using bearings (not shown).

On the end of the spool 50 that is opposite the first end 92, the spool 50 is supported by a shaft 52 (not shown) which extends into a drive box 94. The drive box 94 connects the spool 50 to a motor 96. The motor 96 is connected in electrical communication with a controller 98. The controller 98 is connected in electrical communication with a power source (not shown) via a conduit 100 which is disposed within the ground 14. The power source (not shown) provides electrical energy to the controller 98, which is capable of controlling the function of the motorized anchoring device 90.

The general function of the motorized anchoring device 90 is similar to the anchoring system 18 (described above); however the motorized anchoring device 90 is capable of retracting the tether 22 via rotation of the spool 50 using a motor 96. The motor 96 is operationally connected to the spool 50 via a drive box 94.

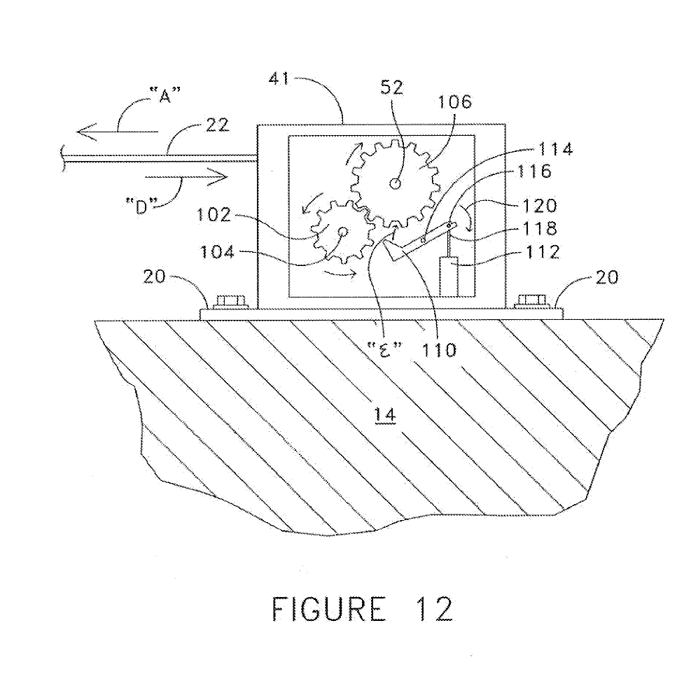

The drive box 94 is employed to mechanically connect the motor 60 to the spool 50 and/or to keep the drive components (e.g., gears, belts, etc.) clean. The drive components disposed within the drive box 94 can be configured in any manner to provide the desired result, such as increasing or decreasing rotational speed, torque, and so forth. For example, referring now to FIG. 12, a side view of an exemplary drive box 94 is illustrated. The drive box 94 is disposed within the housing 41 of a motorized anchoring device 90 that is disposed on the ground 14. The drive box 94 comprises a drive gear 102 that is directly connected to the motor 96 (not shown) via the motor's shaft 104. The drive gear 102 is capable of driving a secondary gear 106 which is directly connected to the spool 50 via shaft 52. The motor 96 (not shown) is capable of rotating the drive gear 102 in a counter-clockwise direction, as illustrated by the directional arrows. As a result of the drive gear's rotation, the secondary gear 106 rotates in a clockwise direction, thus causing the spool 50 to rotate in a clockwise direction, as illustrated by the directional arrows, and retract the tether 22 as illustrated by the directional arrow “D.”.

In addition to the drive components (i.e., motor 96, drive gear 102, secondary gear 106, etc.) the motorized anchoring device 90 also comprises a locking mechanism. The locking mechanism is capable of hindering the deployment of additional tether 22 when engaged. To be more specific, the locking mechanism is capable of hindering the rotation of the secondary gear 106, which hinders the rotation of the spool 50. Therefore, if the spool 50 is incapable of rotating, additional tether 22 cannot be unwound therefrom when the tether 22 is acted upon by a tensile force 44. The locking mechanism comprises a cam locking arm 110 and an actuator 112. The locking arm 110 is rotatably attached to a pivot point 114. The actuator 112 is rotatably attached to pivot point 116.

The actuator 112 is capable of rotating the locking arm 110 about the pivot point 114 when activated. To be more specific, the actuator 112 comprises a rod 118 that is retracted into the actuator 112 when operated. In the present embodiment, the actuator 112 is envisioned to be a solenoid or linear motor that is capable of converting electrical current into linear motion; however of any such device or mechanism that is capable of rotating the locking arm 110 or otherwise hinder the spool 50 from rotating can be employed.

Upon actuation of the actuator 112, the locking arm 110 rotates and engages with the secondary gear 106, as illustrated by directional arrow “E.” When the locking arm 110 engages (i.e., contacts) the secondary gear 106, it cannot rotate thereafter, as illustrated.

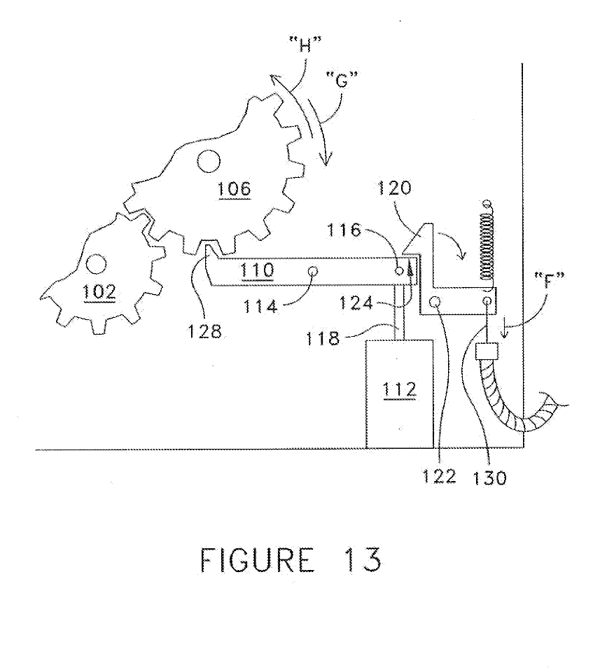

Referring now to FIG. 13, a partial view of an exemplary locking system is illustrated. In the illustration the locking arm 110 is engaged with the secondary gear 106, which cannot rotate as a result. The locking arm 110 was rotated into this position via the actuator 112, which retracted at least a portion of rod 118. The locking arm 118 rotated about the pivot point 114.

In the present embodiment, the actuator 112 is envisioned to be powered by electrical current. It is acknowledged that in emergency situations electrical power may not be available, such as in the example wherein a tornado 12 has knocked-down power lines that supply the conduit 100 with electrical current. In such situations, it is desirable that the locking arm 110 remains engaged with the secondary gear 106 and hinder rotation of the spool 50. Therefore, additional systems can be employed to retain the locking arm 110 in an engaged position. Hence, latch 120 can be employed which is capable of retaining the locking arm 110 in an engaged position. The latch 120 is rotatably attached to a pivot point 122 and configured such that when the locking arm 110 was rotated into the engaged position, the arm end 124 contacted the latch 120 and caused it to rotate (see direction arrow) to allow the locking arm 110 to attain the engaged position. Once the locking arm 110 achieves the engaged position, the latch 120 rotates back to the position illustrated (as it is biased by spring 126) and is capable of hindering the locking arm 110 from rotating.

Attached to a portion of the latch 120 is a cable 130. The cable 130 can be pulled in the direction illustrated by directional arrow “F” to cause the latch 120 to rotate about the pivot point 122 and allow the locking arm 110 to rotate to a non-engaged position. In the non-engaged position, the secondary gear 106 is capable of rotation.

In yet another embodiment, the motorized anchoring device 90 can comprise an internal energy source (e.g., a capacitor, battery, and so forth) such that the motorized anchoring device 90 can be provided power (i.e., electrical current) if conduit 100 cannot supply power thereto.

It is to be understood that the specific configuration of the locking system can be configured in any manner such that the tether 22 cannot deploy from the spool 50. It is also noted that one skilled in the art can recognize that other devices, such as brakes, cogs and such could be employed to provide the same function.

As discussed, the drive components are configured to increase the torque of the spool 50 via the mechanical advantage generated by the drive components, as compared to directly linking the motor 96 to the spool 50 (i.e., the motor 96 turns at a faster rate than the spool 50). This is achieved in the current embodiment through the use of geared drive components. However, it is noted that any such drive components can be employed, which is well understood by those skilled in the art. Further, it is to be understood that increased torque of the spool 50 is desirable such that a greater tensile fore 44 can be exerted on the tether 22, wherein the greater tensile force reduces slack in the portion of tether 22 between the motorized anchoring device 90 and the vehicle 12 and thereby reduces the amount of motion of the vehicle 12 when acted upon by winds 12.

In yet another embodiment of the motorized anchoring device 90, the portion of the locking arm 110 that contacts the secondary gear 106 can be a cog 128. The cog 128 is capable of allowing the secondary gear 106 to rotate in a direction that causes retraction of the tether 22, illustrated by the directional arrow “G.” However, once the forces exerted by the vehicle 12 and the motor 96 equalize, and the motor cannot continue to turn the secondary gear 106, the cog 128 can not allow the secondary gear 106 to turn in a direction that would deploy tether 22, illustrated by directional arrow “H.” Further, if the vehicle 12 is intermittently acted upon by winds 12 that are of sufficient speed to cause the vehicle 12 to sway in a direction away from the motorized anchoring device 90 while the motor 96 is attempting to retract the tether 22, the cog 128 can allow additional tether 22 to be retracted when the wind subsides. In this situation, a motorized anchoring device 90 is desirable as the when the winds 12 temporarily pause, the motor 96 can generate enough torque to retract additional tether 22. However, when the winds 12 build and the motor 96 cannot generate enough torque to overcome the tensile forces 44 on the tether 22, the cog 128 can not allow the secondary gear 106 to rotate, and therefore no additional tether 22 is deployed.

Although not discussed above, the motor 96 is also capable of rotating in either a clockwise or counter-clockwise direction depending upon the orientation (e.g., polarity) of the electrical power supplied thereto via the controller 98. Therefore, if desired, an alternative embodiment can be configured such that the motor 96 can rotate the spool 50 in a direction that deploys the tether 22.

The motorized anchoring device 90 is configured such that it is capable of retracting the tether 22 at a sufficient speed and capable of generating sufficient tension in the tether 22. To be more specific, it is desirable that the motor 96 and the drive box 94 are configured such that the rate at which the tether 22 is retracted is equal to or less than about 1 foot per minute (fpm), or more specifically, equal to or less than about 10 fpm, or even more specifically, equal to or less than about 100 fpm. Further, the amount of tension generated by the motorized anchoring devices 90 can be equal to or less than about 50 lbs., or even more specifically, equal to or less than about 500 lbs., or even more specifically, equal to or less than about 5000 lbs. However, to those skilled in the art it is to be apparent that space constraints (e.g., the size of the motorized anchoring device 90) can be a consideration, and therefore a balance of the amount of tension that can be generated and the retraction rate can be considered during design of the motorized anchoring device 90. It is to be noted if not apparent that the rate of retraction is desirably fast such that the vehicle 12 can be secured quickly. In addition, it should also be noted that the amount of tension generated by the motorized anchoring device 90 is desirable as it can reduce the distance the vehicle 12 can travel when acted upon by winds 12 as well as reduce the occurrence of rocking or swaying of the vehicle 12.

To use a shelter system 10 comprising motorized anchoring devices 90, first the connector 36 is attached to the vehicle 12. To connect the connectors 36 to the vehicle 12, the user grasps the connector 36 and pulls it towards the vehicle 12 (wherein the connector 36 is desirably located such that it is easily located, such as hanging on the housing 41 as is illustrated in FIG. 7). The motorized anchoring device 90 allows the tether 22 to be unwound from the spool 50 as it is in a ready state. To be more specific, when the motorized anchoring device 90 is in a ready state, the motor 96 is not energized nor is the actuator 112 energized. Therefore, the motor 96 is not trying to drive the secondary gear 106 nor is the locking arm 110 engaged with the secondary gear 106.

The user can pull the tether 22 with sufficient force to overcome the inherent resistance encountered by the rotation of the motor 96, the drive components (e.g., primary gear 102, secondary gear 106, etc.) and so forth. It is noted that it is desirable that the drive components rotate with minimal resistance such that the tether 22 is not difficult to pull from the motorized anchoring device 90. To be more specific, a resistance force of less than or equal to 30 lbs (pounds) can be overcome by a majority of users, however a resistance force of less than or equal to 20 lbs., or even more specifically, less than of equal to 10 lbs. is desirable.

After an adequate length of tether 22 has been deployed from the motorized anchoring device 90, the connector 36 is connected to the desired portion of the vehicle (e.g., suspension, rim, frame, trailer hitch, sub-frame, leaf spring, torsion rod, etc.). Once connected, the tether 22 is retracted into the motorized anchoring devices 90 to secure the vehicle 12 to the ground 14. The retraction of the tether 22 is controlled by controller 98, which is capable of supplying electrical current to the motor 96. The controllers 98 can be signaled to begin the retraction of the tethers 22 using any means, such as a remote control (not shown) which can be kept within the vehicle 12, or a switch located on the motorized anchoring device 90. In another embodiment, a signal can sent through the conduit 100 to the controller 98 via a switch located near the vehicle. For example, in one embodiment, once the connector 36 has been connected to the vehicle 12, the user enters the vehicle 12 and pushes a button on a remote control. The remote control transmits an electromagnetic signal (e.g., microwaves) that is received by the controller 98. Once the signal has been received, the controller 98 initiates the retraction of the tethers 22. Once the tethers have been retracted, the controller 98 energizes the actuator 112 which causes the locking arm 110 to engage with the secondary gear 106. Once engaged, the secondary gear 106 cannot rotate and the vehicle 12 is secured to the ground 14. Thereafter, additional motorized anchoring devices 90 can be attached to the vehicle 12.

In yet another embodiment, a plurality of motorized anchoring devices 90 can be connected to each other via electrical connections. To be more specific, in one embodiment employing four motorized anchoring devices 90, each connector 36 can be connected to the vehicle 12. After the connectors 36 have been connected, a single controller 98 can instruct the operation of the plurality of motorized anchoring devices 90 utilizing a switch, a remote control, and so forth.

The controller 98 can be equipped to determine when to cease the operation of the motor 96 such that damage is not incurred. In one embodiment, the controller 98 can be provided with feedback as to the rotation of the motor 96 in the form of an electrical signal which can be employed to assist the controller 98 in determining when to cease operation of the motor 96. To be more specific, the electrical signal can be a torque measurement, a position measurement, a rotational velocity measurement, or so forth. In yet another embodiment, the controller 96 can utilize the amperage supplied to the motor 96 for the determination. In yet another embodiment, the controller 98 can energize the motor 96 for a period of time that that would account for entire length of the tether 22 if it were deployed and if only a portion of the tether 22 was deployed the motor 96 would reach a point of maximum torque and cease to rotate for the duration of time remaining per the controller 98. Hence, it is to be understood that the controller 98 can employ feedback such as electrical signals, programming, or other means to determine when to cease the operation of the motors 96.

The controller 98 can also be equipped to determine when to energize the actuator 112 to engage the locking arm 110. In one embodiment, the controller 98 can determine to energize the actuator 112 when the motor 96 has reached a pre-determined torque. In yet another embodiment, the controller 98 can determine to energize the actuator 112 when the rotation of the motor 98 is nearing zero. In these embodiments it is envisioned the controller acquires information, such as electrical signals from the drive components (e.g., motor 96). In yet another embodiment, the controller can measure the amperage supplied to the motor 96 to determine when to activate the actuator 112, wherein when the amperage indicates the motor 96 is at a point of peak amperage, or just prior to a point of peek amperage, the actuator 112 can be energized to engage the locking arm 110 and thus render the spool 50 locked (i.e., the spool 50 cannot rotate).

The controller 98 can be any device capable of the functions described, and can comprise, but is not limited to, a processor(s), computer(s), and so forth, and can employ memory, storage, register(s), timing, interrupt(s), communication interfaces(s), input/output signal interface(s), and so forth, as well as combinations comprising at least one of the foregoing. Furthermore, the controller 98 can include input signal processing and filtering capabilities that enable accurate sampling and conversion of acquisitions of such signals from various sensor(s). For example, an “on/off” controller, proportional controller, and/or a proportional-integral-derivative controller (e.g. with advanced “fuzzy-logic” capabilities), and the like can be employed.

In addition to the controller 98, sensor(s) and other equipment can be employed in operable communication with the motorized anchoring device 90 and its components (e.g., motor 96) enabling its function, such as probe(s), transducer(s), cell(s), meter(s), switch(as), and so forth, as well as combinations comprising at least one of the foregoing.

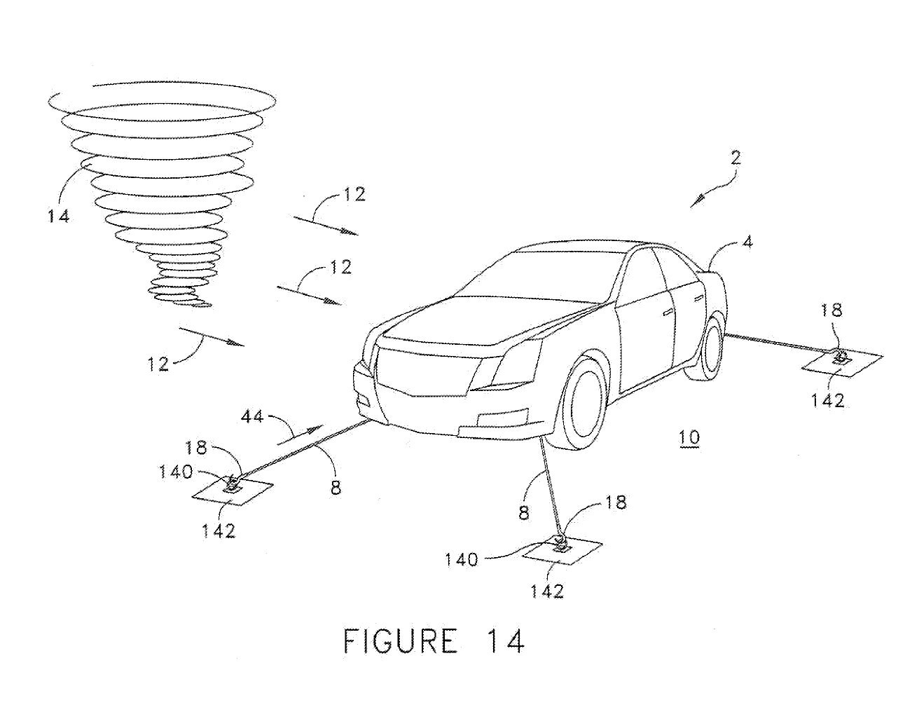

Referring now to FIG. 14, a perspective view of an exemplary vehicle based shelter system 10 is illustrated. In the illustration, it is noted that the tethers 22 are joined to connectors 36 which are removably attached to an anchoring system 18. The anchoring system 18s are secured into the ground 14, and capable of withstanding the tensile forces 44 that may be exerted thereon by the vehicle 12 (via the tethers 22) when it is acted upon by the winds 12 of a tornado.

In the specific embodiment illustrated, the anchoring system 18 comprises rings 140 that are connected to concrete footings 142. The rings 140 can be configured such that they are movable and can lay on the top surface of the concrete footings 142. The concrete footings 142 extend into the ground 14 a sufficient distance to resist forced exerted thereon the vehicle 12 when acted upon by winds 12. The concrete footings 142 can be constructed such that they extend approximately five feet into the ground 14 (i.e., depth). The depth of the concrete footings 142 influence the tensile forces that the concrete footings 142 can withstand, as well as weight, shape, and so forth.

As illustrated, the concrete footings 142 have a square geometry of approximately 18 inches on each side (i.e. 18 inches×18 inches×5 ft), however can comprise any shape (e.g., circular, oblong, irregular, and so forth). Although illustrated as separate footings in FIG. 14, the concrete footings 142 can also be joined in any configuration. For example, in another embodiment the concrete footings 142 can be joined and comprise one pad of concrete on which the vehicle 12 can park thereon. The pad can comprise rebar reinforced concrete and extend approximately one foot into the ground 14 and comprise a width of about 8 ft. and a length of about 16 ft.

The shelter system 10 illustrated in FIG. 14 can comprise tethers 22 having connectors 36 attached on both ends of the tether 22, such that a connector 36 attached to a first end can connect to a ring 140 and a second connector 36 that is on the opposite end of the tether 22 can connect to the vehicle 12. In this configuration, the tether 22 is desirably adjustable in length such that any slack in the tether 22 can be reduced prior to use. In one embodiment, ratchet-straps and/or tie-downs can be employed to secure the vehicle 12 to the ground.

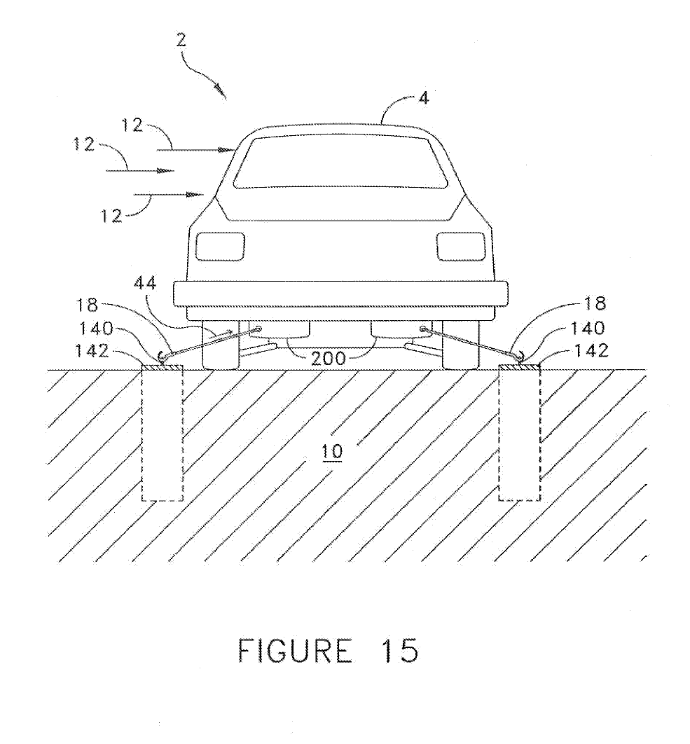

Referring now to FIG. 15, another exemplary shelter system 10 is illustrated. In the illustration, the front of a vehicle 12 is shown. The vehicle 12 comprises securement devices 200 that are secured to the vehicle 12. The securement devices 200 comprise tethers 22 extending therefrom. The tethers 22 are attached to connectors 36 which are connected to anchoring system 18s comprising rings 140 that are attached to concrete footings 142. The concrete footings 142 are disposed in the ground 14, and capable of withstanding any tensile forces 44 that may be exerted on the tethers 22 by the vehicle 12 when winds 12 act thereon, such as when the vehicle is acted upon by a tornado.

The footings 142 extends into the ground 14 a sufficient distance such that when forces are applied to the securement device (6, 90, 200) by the tether 22, the footing remains within the ground 14. The footing 142 can comprise concrete and/or similar building materials (e.g., mortar, gravel, etc.). The footing 142 can be formed by excavating the ground 14 and pouring the concrete therein. To be even more specific, the ground 14 can be excavated and a Sonotube® (not shown, manufactured by Sonoco Products Company, Hartsville, S.C.) can be inserted into the excavated area. Once the Sonotube® is placed in the excavation, it can be temporarily secured by depositing gravel, dirt, stone, etc., into and/or around the Sonotube®. Once temporarily secured, the Sonotube® can be leveled vertical and then the area around the tube can be back filled. Thereafter, concrete can be poured into the Sonotube® to form the footing 142.

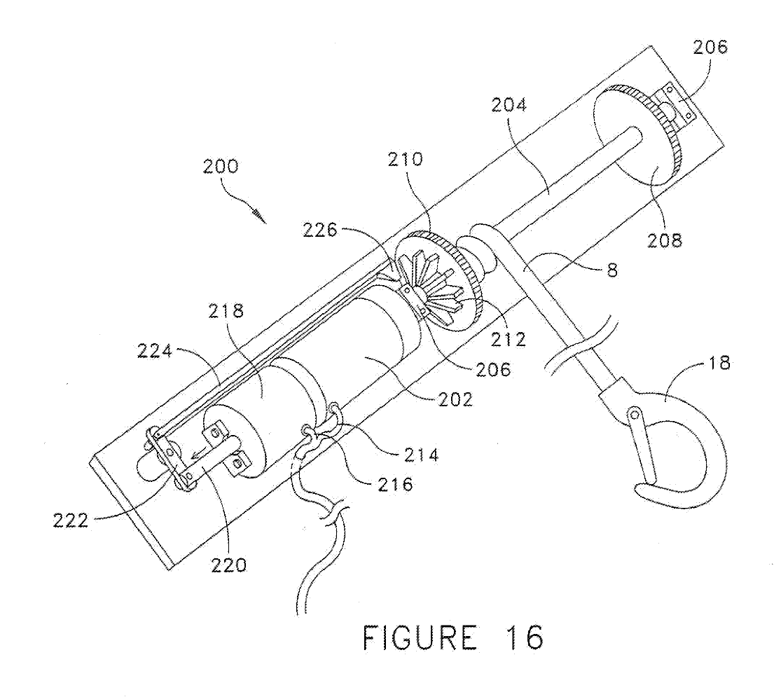

Referring now to FIG. 16, a perspective cut-away view of an exemplary securement device 200 is illustrated. The securement device 200 generally comprises a motor 202 that is operably connected to a shaft 204. The shaft 204 is supported by supports 206 that support the shaft 204 and allow it to rotate therein, utilizing bearings, bushings, or the like (not illustrated). Connected to the shaft 204 is a plate 208 which is capable of containing the tether 22 as it is wound onto the shaft 204 via rotation of the motor 202. Also disposed on the shaft 204 is a lock-plate. The lock-plate comprises a plate 210 and a ribbed-hub 212. The plate 210 is capable of containing the tether 22 as it is wound around the shaft 204 due to rotation of the motor 202.

The motor 202 comprises an electrical conduit 214 that is operably attached thereto. The conduit 214 is capable of supplying electrical energy to the motor 202 to cause the motor 202 to rotate. Depending upon the polarity of the electrical energy supplied thereto, the motor 202 can rotate in either a clockwise or counter-clockwise direction. To be more specific, if it is desired that the tether 22 is wound onto the shaft 204, electrical energy can be supplied with the corresponding polarity to cause the motor 202 to rotate the shaft 204 in a direction that winds the tether 22 onto the shaft 204. Alternatively, if it is desired that the tether 22 is unwound from the shaft 204, electrical energy can be supplied to the motor 202 with the corresponding polarity to cause the motor 202 to rotate the shaft 204 in a direction that un-winds the tether 22 from the shaft 204.

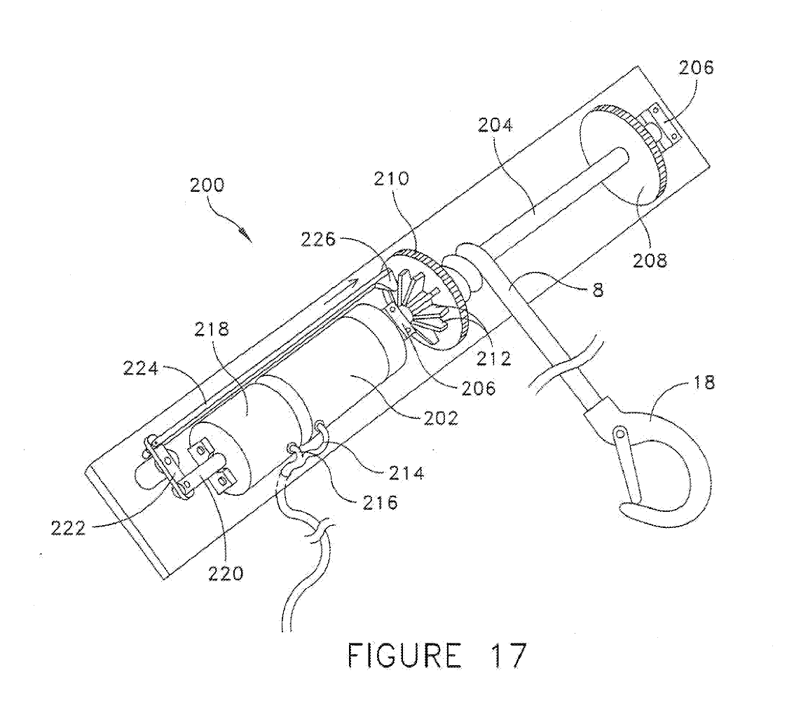

An electrical conduit 216 is operably connected to an actuator 218 (e.g., a linear motor, such as a solenoid). In its non-activated position (i.e., the position when not supplied electrical energy), the actuator is disposed such that the ribbed-hub 212 is not hindered from rotation by a locking-cog 226. However, when supplied electrical energy, the actuator 218 is activated, causing piston 220 to advance in a direction indicated by the directional arrow. When the piston 220 advances, the linkage 222 causes the push rod 224 to translate and engage the locking cog 226 with the ribbed-hub 212. When the locking-cog 226 is engaged with the ribbed-hub 212, the shaft 204 is incapable of rotating, as illustrated in FIG. 17.

It is noted, that any number of securement devices 200 (illustrated in FIGS. 15, 16 and 17) can be mounted on the vehicle 12 in any configuration. For example, two securement devices 200 can be mounted to the front of the unibody or frame of the vehicle, and an additional two securement devices 200 can be mounted to the rear of the unibody or frame of the vehicle. Further, it is to be understood that the securement devices 200 can be mounted, attached, and/or integrated to any portion of the vehicle 12 (e.g., frame, suspension, unibody, bumper, inside the bumper, inside a vehicles trunk, on a trailer hitch, plow frame, and so forth) and can be either temporarily or permanently attached.

Referring now to FIG. 15, an exemplary shelter system 10 comprising a plurality of securement devices 200 is illustrated. To be more specific, the securement devices 200 are assembled within a vehicle 12, such as under the vehicle 12 (e.g., mounted to the unibody). In the illustration, the underside of the vehicle 12 is illustrated wherein the engine 240, transmission 242 and tires 244 are visible. Approximately located in the center of the vehicle can be four securement devices 200. The securement devices 200 comprise tethers 22 that are attached to connectors 36. The tethers 22 are guided from the shafts 204 of their respective securement devices 200 to the points at which they extend from the vehicle 12 via conduits 246.

The conduits 246 guide the tethers 22 through the tortuous path (due to the complexity of the construction of the vehicle) encountered from the securement devices 200 to the points at which the tethers 22 extend from the vehicle 12 (hereinafter referred to as extension points). For example, in the embodiment illustrated, the conduits 246 guide the tethers 22 over the axles 248 such that neither the conduits 246 nor the tethers 22 contact the axles 248. In yet another embodiment, the conduits 246 could be shown routing the tethers 22 over, and/or above, and/or around, exhaust piping.

The materials employed to fabricate the conduit can be any materials that are capable of generally retaining their shape when the system 10 is assembled, such as metal (e.g., stainless steel) pipe or even polymeric tubing. It is acknowledged however that polymeric tubing can require additional securement points (e.g., braces, brackets, etc.) compared to metal tubing.

The materials employed for the various components of the securement devices (6, 90 200) can be fabricated from materials that are capable of withstanding the forces endured during use. To be more specific, polymers (e.g., polyetherimide, nylons, etc.) can be employed and/or metals (e.g., brass, iron, aluminum, etc.), and/or metal alloys (e.g., stainless steel).

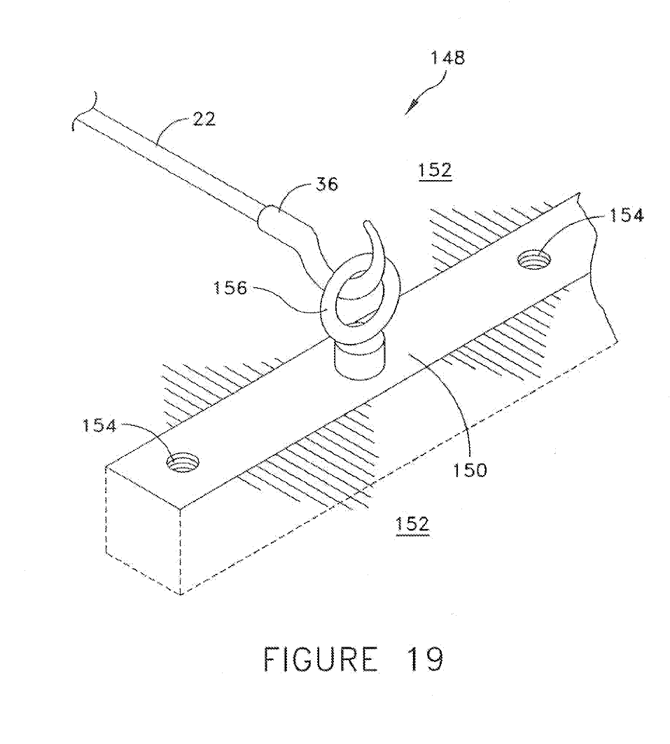

To enable configurability of the position at which the connectors 36 connect to the anchoring system 18 (e.g., rings 140 or other anchoring system components), a configurable anchoring system 18 can be employed. Referring now to FIG. 19, a perspective view of a configurable anchoring system 18, generally designated 148, is illustrated. In the illustration, rails 150 are disposed in a concrete pad 152 which can be disposed in the ground 14 (not shown). The securement rails 150 comprise a plurality of attachment points 154 along its length to which an eyelet 156 can be assembled. The eyelet 156 provides a securement point for the connector 36, which is attached to a securement device 200 via a tether 22.

The rails 150 can be positioned in any orientation in the concrete pad 152 such that when a vehicle 12 is disposed on the concrete pad 152, the eyelets 156 can be disposed in many different positions to allow configurability. For example, in one embodiment, a concrete pad 152 can be constructed for use as a driveway. Under normal conditions when the vehicle 12 is not in use, the vehicle 12 is positioned in approximately a similar position. A rail 150 can be disposed in the concrete pad 152 in a position that is parallel to the front of the vehicle 12 and positioned a distance of about four feet therefrom. Likewise, a rail 150 can be disposed in the concrete pad 152 in a position that is parallel to the back of the vehicle 12 and positioned a distance of about four feet therefrom. Therefore, the variability in the parking of the vehicle 12 is generally between the rails 150 when not in use. To use the system 10, prior to connecting the connector 36, the eyelet(s) 156 can be connected to the rails 150 (e.g., screwing the eyelets 156 into the rails 150). The system 10 is then used similar to that described in relation to FIGS. 15, 16 and 17. In yet another embodiment, the eyelets 156 can remain attached to the rails 150 when not in use.

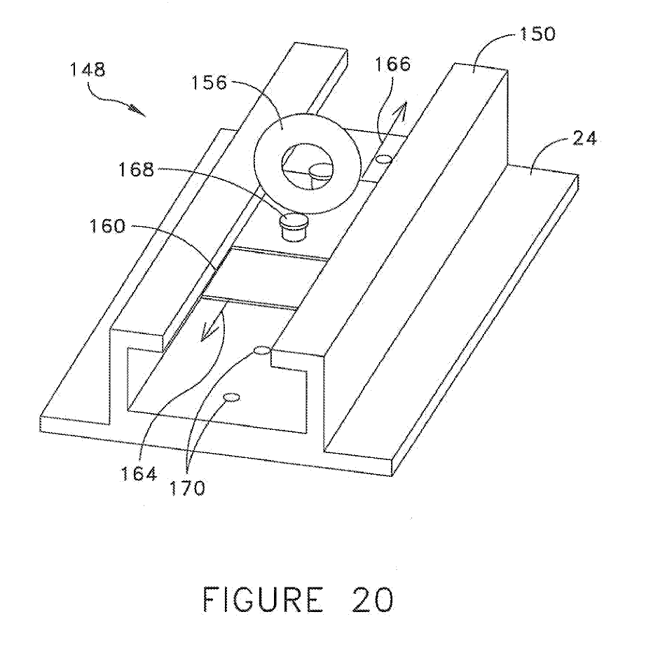

Referring now to FIG. 20, a perspective view of another exemplary configurable anchoring system 148 is illustrated. In the illustration, the configurable anchoring system 148 comprises a rail 150 and a slider 160. The rail 150 can be disposed into a concrete pad (not shown) such that the top surface 162 of the rail 150 is approximately even with the surface of the concrete pad. The rail 150 comprises a retention member 20, which functions to secure the rail 150 into the concrete. When positioning the rail 150 into fluid concrete (i.e., non-cured concrete), the ends of the rail 150 can be capped such that concrete does not flow into the inner portion of the rail 150. The inner portion of the rail 150 is the cavity in which the slider 160 can slide within as directed by directional arrow 164 and 166. The slider 160 comprises securement pins 168 which extend into securement holes 170. When the securement pins 168 extend into the securement holes 170, the slider 160 cannot slide within the rail 150. The securement pins 168 are biased via spring(s) to desirable extend into the securement holes 170. Therefore, to slide the slider 160 within the rail 150, the securement pins 168 are lifted such that the securement pins 168 are retracted from the securement holes 170. The ability of the slider 160 to slide within the rail 150 allows the configurable anchoring system 148 to be adjustable. It is obvious that the rail 150 has been truncated for illustration purposes and would generally comprise a longer length, such as a length that is adequate to extend from the width of a vehicle 12 about three feet on either side of the vehicle 12, for example.

Attached to the slider 160 is an eyelet 156 to which a connector 36 (not shown) can be attached. The size of the eyelet 156 can be configured based on the application, for example, if the vehicle comprises a small car or truck, the eyelet 156 can comprise a construction that is capable of restraining such a vehicle 12 when acted upon by winds 12 of a tornado. In yet another example, if the eyelet 156 is tasked with securing a tractor and/or trailer, the construction of the eyelet 156 can be configured such that is can withstand the increased forces that would be expected to be generated by the larger surface area of the larger vehicle 12.

It is to be understood that a multitude of eyelet-like devices and rail-like devices can be envisioned by one skilled in the mechanical arts and for conciseness will not be fully described herein.

Described herein are vehicle based shelter systems and methods of using the same. These systems can provide shelter for those that do not have ready accessibility to such. As natural phenomena such as tornadoes and hurricanes relentlessly threaten various geographic areas, the need for such a system is significant. Further, such a system can provide life-saving shelter when needed quickly.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

At the outset, unless defined otherwise, technical and scientific terms used herein have the same meaning as is commonly understood by one of skill in the art. The terms “first,” “second,” and “the like”, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). The notation “+/−10%” means that the indicated measurement may be from an amount that is minus 10% to an amount that is plus 10% of the stated value. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the bolt(s) includes one or more bolts).

What is claimed is:

1. A vehicle anchoring system, comprising:
a support member comprising a plurality of spaced apart recessed regions;
a plurality of retention members, each retention member comprising an aperture, each retention member being connected to the support member such that the aperture is disposed over the recessed region;
a first and a second tether, each of the first and second tethers comprising opposing ends and a connector disposed at each of the opposing ends;
wherein, in use, the first tether is connected at one end to a retention member and at the opposing end to the vehicle, and the second tether connected to a retention member at each of the opposing ends, such that the second tether extends through the vehicle compartment.

2. A vehicle-based shelter system, comprising:
a vehicle comprising an internal compartment, wherein the internal compartment is large enough for at least one person to fit therein;
an anchoring system comprising an anchoring device and a tether, wherein the tether can extend from the securement device and attach to the vehicle and wherein the securement device is capable of securing the vehicle such that the vehicle cannot roll over or travel from a point of origin in any direction greater than or equal to about 3 feet; and
wherein the anchoring system is capable of securing the securement device to the ground.

3. A method of anchoring a vehicle to a support member, comprising:
forming a plurality of spaced apart recessed regions in the support member;
connecting a plurality of retention members to the support member, each retention member comprising an aperture, each retention member being connected to the support member such that the aperture is disposed over the recessed region;
providing a first and a second tether, each of the first and second tethers comprising opposing ends and a connector disposed at each of the opposing ends; and
connecting the first tether at one end to a retention member and at the opposing end to the vehicle, and connecting the second tether to a retention member at each of the opposing ends, such that the second tether extends through the vehicle compartment.
